(19) United States
(12) Patent Application Publication
(10) Pub. No.: US 2006/0074658 A1
(43) Pub. Date: Apr. 6, 2006

(54) Systems and methods for hands-free voice-activated devices

(75) Inventor: Lovleen Chadha, San Diego, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Information and Communication Mobile, LLC

(21) Appl. No.: 10/957,482

(22) Filed: Oct. 1, 2004

(51) Int. Cl. G10L 17/00

(52) U.S. Cl. 704/246

(57) ABSTRACT

In some embodiments, systems and methods for hands-free voice-activated devices include devices that are capable of recognizing voice commands from specific users. According to some embodiments, hands-free voice-activated devices may also or alternatively be responsive to an activation identifier.

### TECHNICAL FIELD

The present disclosure relates generally to systems and methods for voice-activated devices, and more particularly to systems and methods for hands-free voice-activated devices.

### BACKGROUND

Electronic devices, such as cellular telephones and computers, are often used in situations where the user is unable to easily utilize typical input components to control the devices. Using a mouse, typing information into a keyboard, or even making a selection from a touch screen display may, for example, be difficult, dangerous, or impossible in certain circumstances (e.g., while driving a car or when both of a user's hands are already being used).

Many electronic devices have been equipped with voice-activation capabilities, allowing a user to control a device using voice commands. These devices however, still require a user to interact with the device by utilizing a typical input component in order to access the voice-activation feature. Cellular telephones, for example, require a user to press a button that causes the cell phone to “listen” for the user's command. Thus, users of voice-activated devices must physically interact with the devices to initiate voice-activation features. Such physical interaction may still be incompatible with or undesirable in certain situations.

Accordingly, there is a need for systems and methods for improved voice-activated devices, and particularly for hands-free voice-activated devices, that address these and other problems found in existing technologies.

### SUMMARY

Methods, systems, and computer program code are therefore presented for providing hands-free voice-activated devices.

According to some embodiments, systems, methods, and computer code are operable to receive voice input, determine if the voice input is associated with a recognized user, determine, in the case that the voice input is associated with the recognized user, a command associated with the voice input, and execute the command. Embodiments may further be operable to initiate an activation state in the case that the voice input is associated with the recognized user and/or to learn to identify voice input from the recognized user.

According to some embodiments, systems, methods, and computer code are operable to receive voice input, determine if the voice input is associated with a recognized activation identifier, and initiate an activation state in the case that the voice input is associated with the recognized activation identifier. Embodiments may further be operable to determine, in the case that the voice input is associated with a recognized activation identifier, a command associated with the voice input, and execute the command.

With these and other advantages and features of embodiments that will become hereinafter apparent, embodiments may be more clearly understood by reference to the following detailed description, the appended claims and the drawings attached herein.

### BRIEF DESCRIPTION OF THE DRAWINGS

FIG. 1 is a block diagram of a system according to some embodiments;

FIG. 2 is a flowchart of a method according to some embodiments;

FIG. 3 is a flowchart of a method according to some embodiments;

FIG. 4 is a perspective diagram of an exemplary system according to some embodiments;

FIG. 5 is a block diagram of a system according to some embodiments; and

FIG. 6 is a block diagram of a system according to some embodiments.

### DETAILED DESCRIPTION

Some embodiments described herein are associated with a “user device” or a “voice-activated device”. As used herein, the term “user device” may generally refer to any type and/or configuration of device that can be programmed, manipulated, and/or otherwise utilized by a user. Examples of user devices include a Personal Computer (PC) device, a workstation, a server, a printer, a scanner, a facsimile machine, a camera, a copier, a Personal Digital Assistant (PDA) device, a modem, and/or a wireless phone. In some embodiments, a user device may be a device that is configured to conduct and/or facilitate communications (e.g., a cellular telephone, a Voice over Internet Protocol (VoIP) device, and/or a walkie-talkie). According to some embodiments, a user device may be or include a “voice-activated device”. As used herein, the term “voice-activated device” may generally refer to any user device that is operable to receive, process, and/or otherwise utilize voice input. In some embodiments, a voice-activated device may be a device that is configured to execute voice commands received from a user. According to some embodiments, a voice-activated device may be a user device that is operable to enter and/or initialize an activation state in response to a user's voice.

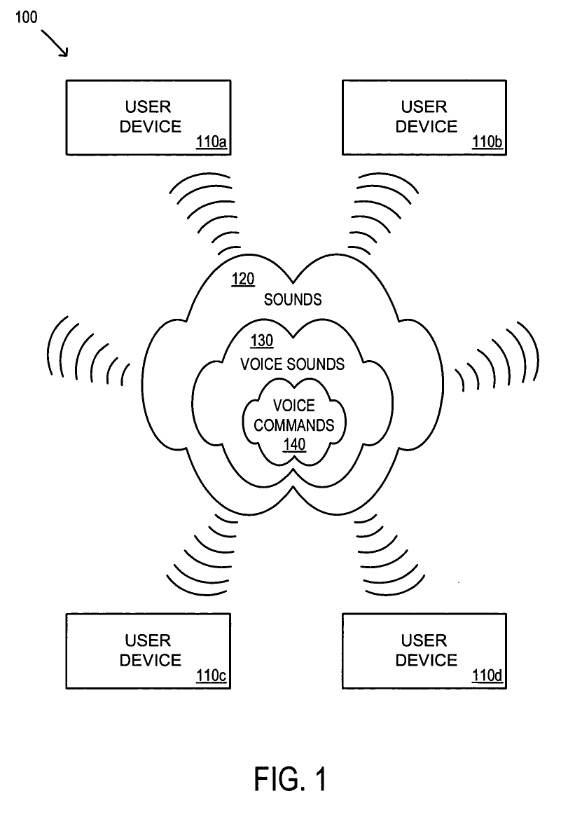

Referring first to FIG. 1, a block diagram of a system 100 according to some embodiments is shown. The various systems described herein are depicted for use in explanation, but not limitation, of described embodiments. Different types, layouts, quantities, and configurations of any of the systems described herein may be used without deviating from the scope of some embodiments. Fewer or more components than are shown in relation to the systems described herein may be utilized without deviating from some embodiments.

The system 100 may comprise, for example, one or more user devices 110a-d. The user devices 110a-d may be or include any quantity, type, and/or configuration of devices that are or become known or practicable. In some embodiments, one or more of the user devices 110a-d may be associated with one or more users. The user devices 110a-d may, according to some embodiments, be situated in one or more environments. The system 100 may, for example, be or include an environment such as a room, a building, and/or any other type of area or location.

Within the environment, the user devices 10a-d may be exposed to various sounds 120. The sounds 120 may include, for example, traffic sounds (e.g., vehicle noise), machinery and/or equipment sounds (e.g., heating and ventilating sounds, copier sounds, or fluorescent light sounds), natural sounds (e.g., rain, birds, and/or wind), and/or other sounds. In some embodiments, the sounds 120 may include voice sounds 130. Voice sounds 130 may, for example, be or include voices originating from a person, a television, a radio, and/or may include synthetic voice sounds. According to some embodiments, the voice sounds 130 may include voice commands 140. The voice commands 140 may, in some embodiments, be or include voice sounds 130 intended as input to one or more of the user devices 110a-d. According to some embodiments, the voice commands 140 may include commands that are intended for a particular user device 110a-d.

One or more of the user devices 110a-d may, for example, be voice-activated devices that accept voice input such as the voice commands 140. In some embodiments, the user devices 110a-d may be operable to identify the voice commands 140. The user devices 110a-d may, for example, be capable of determining which of the sounds 120 are voice commands 140. In some embodiments, a particular user device 10a-d such as the first user device 10a may be operable to determine which of the voice commands 140 (if any) are intended for the first user device 110a.

One advantage to some embodiments is that because the user devices 110a-d are capable of distinguishing the voice commands 140 from the other voice sounds 130, from the sounds 120, and/or from voice commands 140 not intended for a particular user device 110a-d, the user devices 110a-d may not require any physical interaction to activate voice-response features. In such a manner, for example, some embodiments facilitate and/or allow hands-free operation of the user devices 110a-d. In other words, voice commands 140 intended for the first user device 110a may be identified, by the first user device 110a, from among all of the sounds 120 within the environment.

In some embodiments, such a capability may permit voice-activation features of a user device 110a-d to be initiated and/or utilized without the need for physical interaction with the user device 110a-d. In some embodiments, even if physical interaction is still required and/or desired (e.g., to initiate voice-activation features), the ability to identify particular voice commands 140 (e.g., originating from a specific user) may reduce the occurrence of false command identification and/or execution. In other words, voice-activation features may, according to some embodiments, be more efficiently and/or correctly executed regardless of how they are initiated.

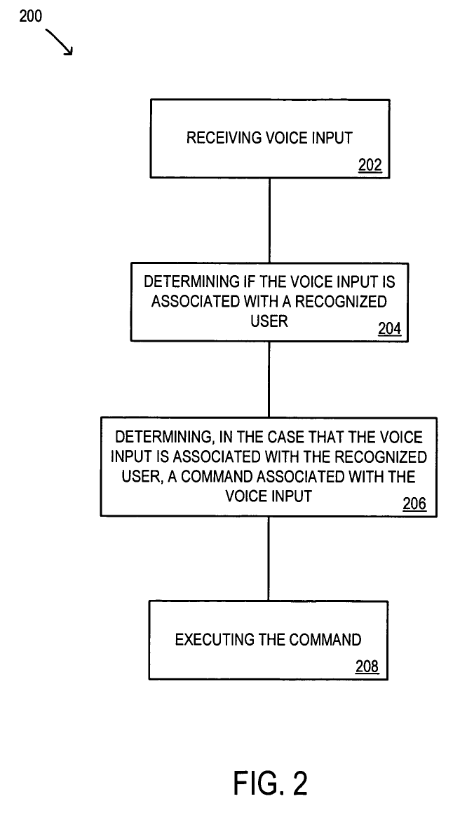

Referring now to FIG. 2, a method 200 according to some embodiments is shown. In some embodiments, the method 200 may be conducted by and/or by utilizing the system 100 and/or may be otherwise associated with the system 100 and/or any of the system components described in conjunction with FIG. 1. The method 200 may, for example, be performed by and/or otherwise associated with a user device 110a-d described herein. The flow diagrams described herein do not necessarily imply a fixed order to the actions, and embodiments may be performed in any order that is practicable. Note that any of the methods described herein may be performed by hardware, software (including microcode), firmware, manual means, or any combination thereof. For example, a storage medium may store thereon instructions that when executed by a machine result in performance according to any of the embodiments described herein.

In some embodiments, the method 200 may begin at 202 by receiving voice input. For example, a user device (such as a user device 110a-d) may receive voice input from one or more users and/or other sources. In some embodiments, other voice sounds and/or non-voice sounds may also be received. Voice input may, according to some embodiments, be received via a microphone and/or may otherwise include the receipt of a signal. The voice input may, for example, be received via sound waves (e.g., through a medium such as the air) and/or via other signals, waves, pulses, tones, and/or other types of communication.

At 204, the method 200 may continue by determining if the voice input is associated with a recognized user. The voice input received at 202 may, for example, be analyzed, manipulated, and/or otherwise processed to determine if the voice input is associated with a known, registered, and/or recognized user. In some embodiments, such as where the voice input is received by a user device, the user device may conduct and/or participate in a process to learn how to determine if voice input is associated with a recognized user. The user of a user device such as a cell phone may, for example, teach the cell phone how to recognize the user's voice. In some embodiments, the user may speak various words and/or phrases to the device and/or may otherwise take actions that may facilitate recognition of the user's voice by the device. In some embodiments, the learning process may be conducted for any number of potential users of the device (e.g., various family members that may use a single cell phone).

According to some embodiments, when voice input is received by the user device, the user device may utilize information gathered during the learning process to identify the user's voice. The user's voice and/or speech pattern may, for example, be compared to received voice and/or sound input to determine if and/or when the user is speaking. In some embodiments, such a capability may permit the device to distinguish the user's voice from various other sounds that may be present in the device's operating environment. The device may not require physical input from the user to activate voice-activation features, for example, because the device is capable of utilizing the user's voice as an indicator of voice-activation initiation. Similarly, even if physical input is required and/or desired to initiate voice-activation features, once they are activated, the device may be less likely to accept and/or process sounds from sources other than the user.

In some embodiments, the method 200 may continue by determining, in the case that the voice input is associated with the recognized user, a command associated with the voice input. For example, a user device may not only receive voice input from a user, it may also process the received input to determine if the input includes a command intended for the device. According to some embodiments, once the device determines that the voice input is associated with the recognized user, the device may analyze the input to identify any commands within and/or otherwise associated with the input.

For example, the user device may parse the voice input (e.g., into individual words) and separately analyze the parsed portions. In some embodiments, any portions within the voice input may be compared to a stored list of pre-defined commands. If a portion of the voice input matches a stored command, then the stored command may, for example, be identified by the user device. According to some embodiments, multiple commands may be received within and/or identified as being associated with the voice input. Stored and/or recognized commands may include any type of commands that are or become know or practicable. Commands may include, for example, letters, numbers, words, phrases, and/or other voice sounds.

In some embodiments, commands may also or alternatively be identified using other techniques. For example, the user device may examine portions of the voice input to infer one or more commands. The natural language of the voice input may, according to some embodiments, be analyzed to determine a meaning associated with the voice input (and/or a portion thereof). The meaning and/or intent of a sentence may, for example, be determined and compared to possible commands to identify one or more commands. In some embodiments, the tone, inflection, and/or other properties of the voice input may also or alternatively be analyzed to determine if any relation to a potential commands exists.

The method 200 may continue, according to some embodiments, by executing the command, at 208. The one or more commands determined at 206 may, for example, be executed and/or otherwise processed (e.g., by the user device). In some embodiments, the command may be a voice-activation command. The voice-activation features of the user device may, for example, be activated and/or initiated in accordance with the method 200. Hands-free operation of the device may, in some embodiments, be possible at least in part because voice-activation commands may be executed without requiring physical interaction between the user and the user device. In some embodiments, even if hands-free operation is not utilized, the commands executed at 208 may be more likely to be accurate (e.g., compared to pervious systems) at least because the voice input may be determined at 204 to be associated with a recognized user (e.g., as opposed to accepting voice input originating from any source).

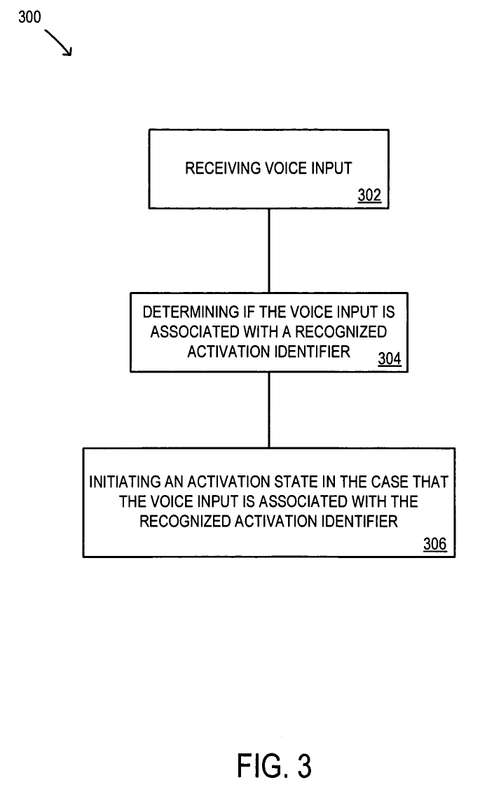

Turning now to FIG. 3, a method 300 according to some embodiments is shown. In some embodiments, the method 300 may be conducted by and/or by utilizing the system 100 and/or may be otherwise associated with the system 100 and/or any of the system components described in conjunction with FIG. 1. The method 300 may, for example, be performed by and/or otherwise associated with a user device 110a-d described herein. In some embodiments, the method 300 may be associated with the method 200 described in conjunction with FIG. 2.

According to some embodiments, the method 300 may begin at 302 by receiving voice input. The voice input may, for example, be similar to the voice input received at 202. In some embodiments, the voice input may be received via any means that is or becomes known or practicable. According to some embodiments, the voice input may include one or more commands (such as voice-activation commands). In some embodiments, the voice input may be received from and/or may be associated with any user and/or other entity. According to some embodiments, the voice input may be received from multiple sources.

The method 300 may continue, in some embodiments, by determining if the voice input is associated with a recognized activation identifier, at 304. According to some embodiments, a user device may be assigned and/or otherwise associated with a particular activation identifier. The device may, for example, be given a name such as “Bob” or “Sue” and/or other assigned other word identifiers such as “Alpha” or “Green”. In some embodiments, the user device may be identified by any type and/or configuration of identifier that is or becomes known. According to some embodiments, an activation identifier may include a phrase, number, and/or other identifier. According to some embodiments, the activation identifier may be substantially unique and/or may otherwise easily distinguish one user device from another.

At 306, the method 300 may continue, for example, by initiating an activation state in the case that the voice input is associated with the recognized activation identifier. Upon receiving and identifying a specific activation identifier (such as “Alpha”), for example, a user device may become active and/or initiate voice-activation features. In some embodiments, the receipt of the activation identifier may take the place of requiring physical interaction with the user device in order to initiate voice-activation features. According to some embodiments, the activation identifier may be received from any source. In other words, anyone that knows the “name” of the user device may speak the name to cause the device to enter an activation state (e.g., a state where the device may “listen” for voice commands).

In some embodiments, the method 300 may also include a determination of whether or not the activation identifier was provided by a recognized user. The determination may, for example, be similar to the determination at 204 in the method 200 described herein. According to some embodiments, only activation identifiers received from recognized users may cause the user device to enter an activation state. Unauthorized users that know the device's name, for example, may not be able to activate the device. In some embodiments, such as where any user may activate the device by speaking the device's name (e.g., the activation identifier), once the device is activated it may “listen” for commands (e.g., voice-activation commands). According to some embodiments, the device may only accept and/or execute commands that are received from a recognized user. Even if an unrecognized user is able to activate the device, for example, in some embodiments only a recognized user may be able to cause the device to execute voice commands.

In some embodiments, the use of the activation identifier to activate the device may reduce the amount of power consumed by the device in the inactive state (e.g., prior to initiation of the activation state at 306). In the case that the device is only required to “listen” for the activation identifier (e.g., as opposed to any possible voice-activation command), for example, the device may utilize a process that consumes a small amount of power. An algorithm used to determine the activation identifier (such as “Alpha) may, for example, be a relatively simple algorithm that is only capable of determining a small sub-set of voice input (e.g., the activation identifier). In the case that the inactive device is only required to identify the word “Alpha”, for example, the device may utilize a low Million Instructions Per Second (MIPS) algorithm that is capable of identifying the single word of the activation identifier. In some embodiments, once the activation identifier has been determined using the low-power, low MIPS, and/or low complexity algorithm, the device may switch to and/or otherwise implement one or more complex algorithms capable of determining any number of voice-activation commands.

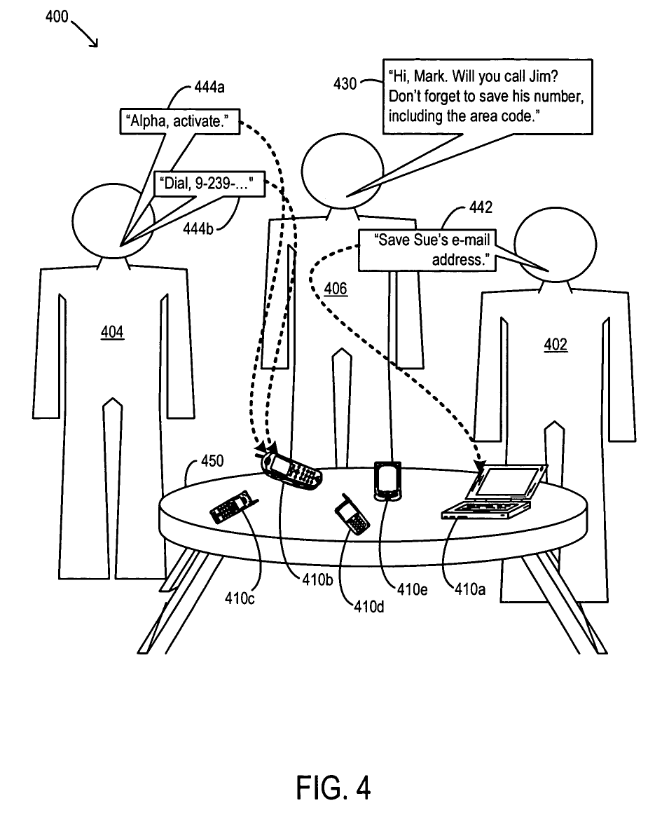

Turning now to FIG. 4, a perspective diagram of an exemplary system 400 according to some embodiments is shown. The system 400 may, for example, be utilized to implement and/or perform the methods 200, 300 described herein and/or may be associated with the system 100 described in conjunction with any of FIG. 1, FIG. 2, and/or FIG. 3. In some embodiments, fewer or more components than are shown in FIG. 4 may be included in the system 400. According to some embodiments, different types, layouts, quantities, and configurations of systems may be used.

The system 400 may include, for example, one or more users 402, 404, 406 and/or one or more user devices 410a-e. In some embodiments, the users 402, 404, 406 may be associated with and/or produce various voice sounds 430 and/or voice commands 442, 444. The system 400 may, according to some embodiments, be or include an environment such as a room and/or other area. In some embodiments, the system 400 may include one or more objects such as a table 450. For example, the system 400 may be a room in which several user devices 410a-e are placed on the table 450. The three users 402, 404, 406 may also be present in the room and may speak to one another and/or otherwise create and/or produce various voice sounds 430 and/or voice commands 442, 444.

In some embodiments, the first user 402 may, for example, utter a first voice command 442 that includes the sentence “Save Sue's e-mail address.” The first voice command 442 may, for example, be directed to the first user device 410a (e.g., the laptop computer). The laptop 410a may, for example, be associated with the first user 402 (e.g., the first user 402 may own and/or otherwise operate the laptop 410a and/or may be a recognized user of the laptop 410a). According to some embodiments, the laptop 410a may recognize the voice of the first user 402 and may, for example, accept and/or process the first voice command 442. In some embodiments, the second and third users 404, 406 may also be talking.

The third user 406 may, for example, utter a voice sound 430 that includes the sentences shown in FIG. 4. According to some embodiments, the laptop 410a may be capable of distinguishing the first voice command 442 (e.g., the command intended for the laptop 410a) from the other voice sounds 430 and/or voice commands 444 within the environment. Even though the voice sounds 430 may include pre-defined command words (such as “call” and “save”), for example, the laptop 410a may ignore such commands because they do not originate from the first user 402 (e.g., the user recognized by the laptop 410a).

In some embodiments, the third user 406 may be a recognized user of the laptop 410a (e.g., the third user 406 may be the spouse of the first user 402 and both may operate the laptop 410a). The laptop 410a may, for example, recognize and/or process the voice sounds 430 made by the third user 406 in the case that the third user 406 is a recognized user. According to some embodiments, voice sounds 430 and/or commands 442 from multiple recognized users (e.g., the first and third users 402, 406) may be accepted and/or processed by the laptop 410a. In some embodiments, the laptop 410a may prioritize and/or choose one or more commands to execute (such as in the case that commands are conflict).

According to some embodiments, the laptop 410a may analyze the first voice command 442 (e.g., the command received from the recognized first user 402). The laptop 410a may, for example, identify a pre-defined command word “save” within the first voice command 442. The laptop 410a may also or alternatively analyze the first voice command 442 to determine the meaning of speech provided by the first user 402. For example, the laptop 410a may analyze the natural language of the first voice command 442 to determine one or more actions the laptop 410a is desired to take.

The laptop 410a may, in some embodiments, determine that the first user 402 wishes that the e-mail address associated with the name “Sue” be saved. The laptop 410a may then, for example, identify an e-mail address associated with and/or containing the name “Sue” and may store the address. In some embodiments, such as in the case that the analysis of the natural language may indicate multiple potential actions that the laptop 410a should take, the laptop 410a may select one of the actions (e.g., based on priority or likelihood based on context), prompt the first user 402 for more input (e.g., via a display screen or through a voice prompt), and/or await further clarifying instructions from the first user 402.

In some embodiments, the second user 404 may also or alternatively be speaking. The second user 404 may, for example, provide the second voice command 444, directed to the second user device 410b (e.g., one of the cellular telephones). According to some embodiments, the cell phone 410b may be configured to enter an activation state in response to an activation identifier. The cell phone 410b may, for example, be associated with, labeled, and/or named “Alpha”. The second user 404 may, in some embodiments (such as shown in FIG. 4), speak an initial portion of a second voice command 444a that includes the phrase “Alpha, activate.”

According to some embodiments, when the cell phone 410b “hears” its “name” (e.g., Alpha), it may enter an activation state in which it actively listens for (and/or is otherwise activated to accept) further voice commands. In some embodiments, the cell phone 410b may enter an activation state when it detects a particular combination of words and/or sounds. The cell phone 410b may require the name Alpha to be spoken, followed by the command “activate”, for example, prior to entering an activation state. In some embodiments (such as where the device's name is a common name such as “Bob”), the additional requirement of detecting the command “activate” may reduce the possibility of the cell phone activating due to voice sounds not directed to the device (e.g., when someone in the environment is speaking to a person named Bob).

In some embodiments, the second user 404 may also or alternatively speak a second portion of the second voice command 444b. After the cell phone 410b is activated, for example (e.g., by receiving the first portion of the second voice command 444a), the second user 404 may provide a command, such as “Dial, 9-239 . . . ” to the cell phone 410b. According to some embodiments, the second portion of the second voice command 444b may not need to be prefaced with the name (e.g., Alpha) of the cell phone 410b. For example, once the cell phone 410b is activated (e.g., by receiving the first portion of the second voice command 444a) it may stay active (e.g., continue to actively monitor for and/or be receptive to voice commands) for a period of time.

In some embodiments, the activation period may be pre-determined (e.g., a thirty-second period) and/or may be determined based on the environment and/or other context (e.g., the cell phone 410b may stay active for five seconds after voice commands have stopped being received). According to some embodiments, during the activation period (e.g., while the cell phone 410b is in an activation state), the cell phone 410b may only be responsive to commands received from a recognized user (e.g., the second user 404). Any user 402, 404, 406 may, for example, speak the name of the cell phone 410b to activate the cell phone 410b, but then only the second user 404 may be capable of causing the cell phone 410b to execute commands. According to some embodiments, even the activation identifier may need to be received from the second user 404 for the cell phone 410b to enter the activation state.

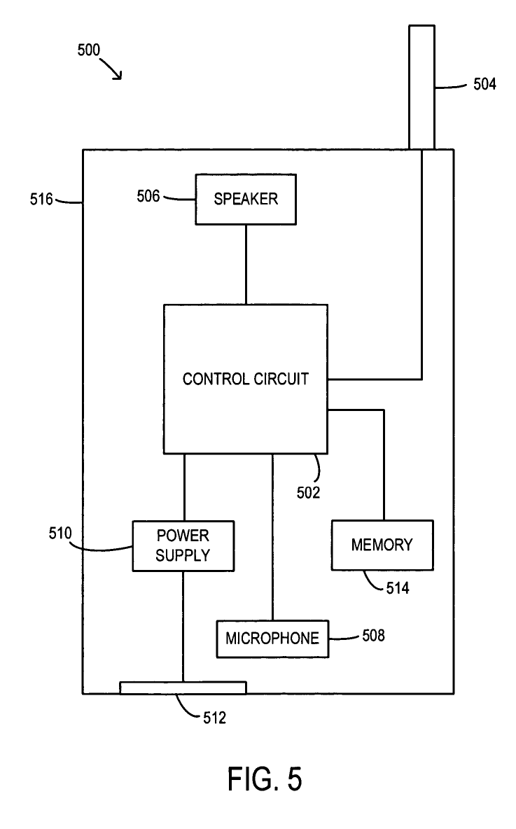

Referring now to FIG. 5, a block diagram of a system 500 according to some embodiments is shown. The system 500 may, for example, be utilized to implement and/or perform the methods 200, 300 described herein and/or may be associated with the systems 100, 400 described in conjunction with any of FIG. 1, FIG. 2, FIG. 3, and/or FIG. 4. In some embodiments, fewer or more components than are shown in FIG. 5 may be included in the system 500. According to some embodiments, different types, layouts, quantities, and configurations of systems may be used.

In some embodiments, the system 500 may be or include a wireless communication device such as a wireless telephone, a laptop computer, or a PDA. According to some embodiments, the system 500 may be or include a user device such as the user devices 110a-d, 410a-e described herein. The system 500 may include, for example, one or more control circuits 502, which may be any type or configuration of processor, microprocessor, micro-engine, and/or any other type of control circuit that is or becomes known or available. In some embodiments, the system 500 may also or alternatively include an antenna 504, a speaker 506, a microphone 508, a power supply 510, a connector 512, and/or a memory 514, all and/or any of which may be in communication with the control circuit 502. The memory 514 may store, for example, code and/or other instructions operable to cause the control circuit 502 to perform in accordance with embodiments described herein.

The antenna 504 may be any type and/or configuration of device for transmitting and/or receiving communications signals that is or becomes known. The antenna 504 may protrude from the top of the system 500 as shown in FIG. 5 or may also or alternatively be internally located, mounted on any other exterior portion of the system 500, or may be integrated into the structure or body 516 of the wireless device itself. The antenna 504 may, according to some embodiments, be configured to receive any number of communications signals that are or become known including, but not limited to, Radio Frequency (RF), Infrared Radiation (IR), satellite, cellular, optical, and/or microwave signals.

The speaker 506 and/or the microphone 508 may be or include any types and/or configurations of devices that are capable of producing and capturing sounds, respectively. In some embodiments, the speaker 506 may be situated to be positioned near a user's ear during use of the system 500, while the microphone 508 may, for example, be situated to be positioned near a user's mouth. According to some embodiments, fewer or more speakers 506 and/or microphones 508 may be included in the system 500. In some embodiments, the microphone 508 may be configured to receive sounds and/or other signals such as voice sounds or voice commands as described herein (e.g., voice sounds 130, 430 and/or voice commands 140, 442, 444).

The power supply 510 may, in some embodiments, be integrated into, removably attached to any portion of, and/or be external to the system 500. The power supply 510 may, for example, include one or more battery devices that are removably attached to the back of a wireless device such as a cellular telephone. The power supply 510 may, according to some embodiments, provide Alternating Current (AC) and/or Direct Current (DC), and may be any type or configuration of device capable of delivering power to the system 500 that is or becomes known or practicable. In some embodiments, the power supply 510 may interface with the connector 512. The connector 512 may, for example, allow the system 500 to be connected to external components such as external speakers, microphones, and/or battery charging devices. According to some embodiments, the connector 512 may allow the system 500 to receive power from external sources and/or may provide recharging power to the power supply 510.

In some embodiments, the memory 514 may store any number and/or configuration of programs, modules, procedures, and/or other instructions that may, for example, be executed by the control circuit 502. The memory 514 may, for example, include logic that allows the system 500 to learn, identify, and/or otherwise determine the voice sounds and/or voice commands of one or more particular users (e.g., recognized users). In some embodiments, the memory 514 may also or alternatively include logic that allows the system 500 to identify one or more activation identifiers and/or to interpret the natural language of speech.

According to some embodiments, the memory 514 may store a database, tables, lists, and/or other data that allow the system 500 to identify and/or otherwise determine executable commands. The memory 514 may, for example, store a list of recognizable commands that may be compared to received voice input to determine actions that the system 500 is desired to perform. In some embodiments, the memory 514 may store other instructions such as operation and/or command execution rules, security features (e.g., passwords), and/or user profiles.

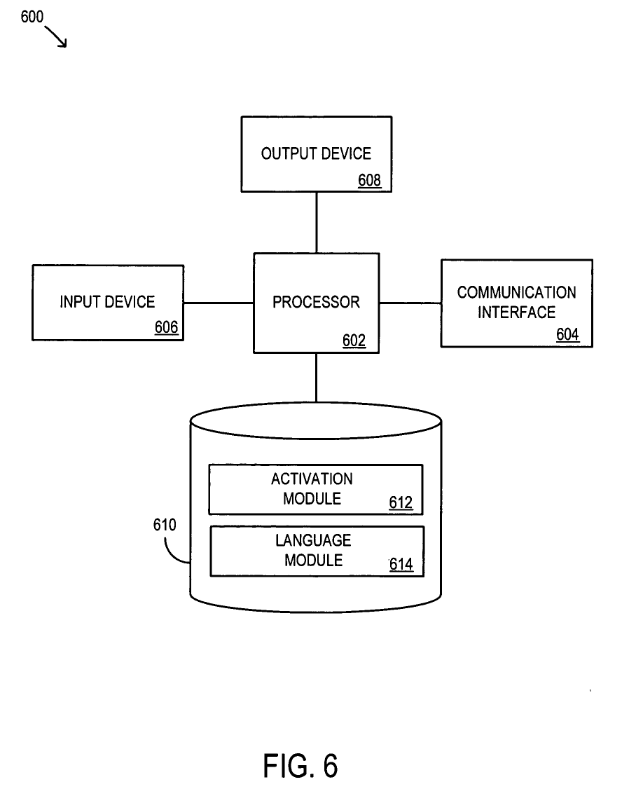

Turning now to FIG. 6, a block diagram of a system 600 according to some embodiments is shown. The system 600 may, for example, be utilized to implement and/or perform the methods 200, 300 described herein and/or may be associated with the systems 100, 400, 500 described in conjunction with any of FIG. 1, FIG. 2, FIG. 3, FIG. 4, and/or FIG. 5. In some embodiments, fewer or more components than are shown in FIG. 6 may be included in the system 600. According to some embodiments, different types, layouts, quantities, and configurations of systems may be used.

In some embodiments, the system 600 may be or include a communication device such as a PC, a PDA, a wireless telephone, and/or a notebook computer. According to some embodiments, the system 600 may be a user device such as the user devices 110a-d, 410a-e described herein. In some embodiments, the system 600 may be a wireless communication device (such as the system 500) that is used to provide hands-free voice-activation features to a user. The system 600 may include, for example, one or more processors 602, which may be any type or configuration of processor, microprocessor, and/or micro-engine that is or becomes known or available. In some embodiments, the system 600 may also or alternatively include a communication interface 604, an input device 606, an output device 608, and/or a memory device 610, all and/or any of which may be in communication with the processor 602. The memory device 610 may store, for example, an activation module 612 and/or a language module 614.

The communication interface 604, the input device 606, and/or the output device 608 may be or include any types and/or configurations of devices that are or become known or available. According to some embodiments, the input device 606 may include a keypad, one or more buttons, and/or one or more softkeys and/or variable function input devices. The input device 606 may include, for example, any input component of a wireless telephone and/or PDA device, such as a touch screen and/or a directional pad or button.

The memory device 610 may be or include, according to some embodiments, one or more magnetic storage devices, such as hard disks, one or more optical storage devices, and/or solid state storage. The memory device 610 may store, for example, the activation module 612 and/or the language module 614. The modules 612, 614 may be any type of applications, modules, programs, and/or devices that are capable of facilitating hands-free voice-activation. Either or both of the activation module 612 and the language module 614 may, for example, include instructions that cause the processor 602 to operate the system 600 in accordance with embodiments as described herein.

For example, the activation module 612 may include instructions that are operable to cause the system 600 to enter an activation state in response to received voice input. The activation module 612 may, in some embodiments, cause the processor 602 to conduct the one or both of the methods 200, 300 described herein. According to some embodiments, the activation module 612 may, for example, cause the system 600 to enter an activation state in the case that voice sounds and/or voice commands are received from a recognized user and/or that include a particular activation identifier (e.g., a name associated with the system 600).

In some embodiments, the language module 614 may identify and/or interpret the voice input that has been received (e.g., via the input device 606 and/or the communication interface 604). The language module 614 may, for example, determine that received voice input is associated with a recognized user and/or determine one or more commands that may be associated with the voice input. According to some embodiments, the language module 614 may also or alternatively analyze the natural language of the voice input (e.g., to determine commands associated with the voice input). In some embodiments, such as in the case that the activation module 612 causes the system 600 to become activated, the language module 614 may identify and/or execute voice commands (e.g., voice-activation commands).

The several embodiments described herein are solely for the purpose of illustration. Those skilled in the art will note that various substitutions may be made to those embodiments described herein without departing from the spirit and scope of the present invention. Those skilled in the art will also recognize from this description that other embodiments may be practiced with modifications and alterations limited only by the claims.

What is claimed is:

1. A method, comprising:
receiving voice input;
determining if the voice input is associated with a recognized user;
determining, in the case that the voice input is associated with the recognized user, a command associated with the voice input; and
executing the command.

2. The method of claim 1, further comprising:
initiating an activation state in the case that the voice input is associated with the recognized user.

3. The method of claim 2, further comprising:
listening, during the activation state, for voice commands provided by the recognized user.

4. The method of claim 2, further comprising:
terminating the activation state upon the occurrence of an event.

5. The method of claim 4, wherein the event includes at least one of a lapse of a time period or a receipt of a termination command.

6. The method of claim 1, further comprising:
learning to identify voice input from the recognized user.

7. The method of claim 6, wherein the learning is conducted for each of a plurality of recognized users.

8. The method of claim 1, wherein the determining the command includes:
comparing at least one portion of the voice input to a plurality of stored voice input commands.

9. The method of claim 1, wherein the determining the command includes:
interpreting a natural language of the voice input to determine the command.

10. A method, comprising:
receiving voice input;
determining if the voice input is associated with a recognized activation identifier; and
initiating an activation state in the case that the voice input is associated with the recognized activation identifier.

11. The method of claim 10, further comprising:
determining, in the case that the voice input is associated with a recognized activation identifier, a command associated with the voice input; and
executing the command.

12. The method of claim 11, wherein the determining the command includes:
comparing at least one portion of the voice input to a plurality of stored voice input commands.

13. The method of claim 11, wherein the determining the command includes:
interpreting a natural language of the voice input to determine the command.

14. The method of claim 10, wherein the activation state is only initiated in the case that the recognized activation identifier is identified as being provided by a recognized user.

15. The method of claim 10, further comprising:
listening, during the activation state, for voice commands provided by a recognized user.

16. The method of claim 15, further comprising:
learning to identify voice input from the recognized user.

17. The method of claim 16, wherein the learning is conducted for each of a plurality of recognized users.

18. The method of claim 10, further comprising:
terminating the activation state upon the occurrence of an event.

19. The method of claim 18, wherein the event includes at least one of a lapse of a time period or a receipt of a termination command.

20. A system, comprising:
a memory configured to store instructions;
a communication port; and
a processor coupled to the memory and the communication port, the processor being configured to execute the stored instructions to:
receive voice input;
determine if the voice input is associated with a recognized user;
determine, in the case that the voice input is associated with a recognized user, a command associated with the voice input; and
execute the command.
